(19) United States
(12) Patent Application Publication
(10) Pub. No.: US 2007/0077491 A1
(43) Pub. Date: Apr. 5, 2007

(54) Electrode, method of its production, metal-air fuel cell and metal hydride cell

(76) Inventor: Trygve Burchardt, Trondheim (NO)

Correspondence Address: PATTERSON & SHERIDAN, L.L.P., 3040 POST OAK BOULEVARD, SUITE 1500, HOUSTON, TX, 77056, US

(21) Appl. No.: 10/595,470

(22) PCT Filed: Oct. 21, 2004
(86) PCT No.: PCT/NO04/00321

§ 371 Date: Dec. 12, 2006

(30) Foreign Application Priority Data
Oct. 21, 2003 (NO) 2003 4702

(51) Int. Cl. H01M 4/58; H01M 4/46; H01M 4/38; H01M 4/42

(52) U.S. Cl. 429/218.2; 252/182.1; 429/231.6; 429/221; 429/229; 429/218.1

(57) ABSTRACT

The invention described concerns an anode electrode comprising a hydrogen storage material/alloy and a high energy density metal. In addition a hydrogen electrocatalyst may be added to increase the hydrogen reaction rate. The high energy density metal is selected from a group consisting of Al, Zn, Mg and Fe, or from a combination of these metals. A method of production of an electrode comprising a hydrogen storage alloy and a high energy density metal is also described. The method comprises sintering or binding a high energy density metal powder and/or hydrogen storage alloy into at least one thin street, and calendaring or pressing said sheet forming the electrode. The anode electrode may be used in metal hydride batteries and metal air fuel cells.

### INTRODUCTION

The invention relates to an electrode for use in an electrochemical cell. More particularly, the invention relates to the solution for the corrosion problems for metals such as aluminium (Al), magnesium (Mg), zinc (Zn) and iron (Fe) in metal-air fuel cells and metal hydride batteries. The invention also provides a method to increase the energy capacity between charging and the peak power density for metal-air fuel cells and Ni/Metal hydride battery systems.

### BACKGROUND

Traditional Fuel Cells

Fuel cells are constructed in order to transform chemical energy into electrical energy with high efficiency. In contrast to batteries, where chemical energy is stored within the systems, fuel cells are constructed so that the reacting species are fed from the environment. This results in energy efficient systems with high energy density per unit weight and volume. In most fuel cells the cathodic reaction is the reduction of oxygen from the air. Hydrogen is often used as the energy carrier, and is oxidised in an anodic reaction. The storage of hydrogen is one of the main challenges to be overcome before such systems can be mass manufactured. The energy density of hydrogen per weight and volume is low compared to traditional fossil fuels.

At temperatures below 150° C. two main types of fuel cells exist:
1. In the PEM (proton exchange membrane) fuel cell the electrodes for the oxygen and hydrogen reactions are deposited onto a perfluorosulfone acid (PFSA) polymer membrane (Naflon). This membrane effectively separates the two reactions and gives the system high ionic conductivity at temperatures above 70° C. The electrodes are thin layers (<20 μm). High catalytic activity is obtained by using a carbon support with deposited noble metal catalysts.
2. In the alkaline fuel cell (AFC) the electrodes are made from porous layers with a thickness of 300 to 1000 μm. The hydrogen and oxygen reactions take place inside the layer. An alkaline electrolyte with high ionic conductivity separates the two electrodes. The most common method to produce the electrodes is by mixing porous powders and catalysts with polytetrafluoroethylene (PTFE or Teflon). A double pore structure with hydrophobic and hydrophilic pores produce pathways for liquid and gas transport within the electrode. For the anodic reaction hydrogen is transported through gas channels in the structure. The hydrogen reaction takes place on catalytic particles distributed inside the porous structure. A carbon support is often used for the catalytic particles. This carbon support has no catalytic activity towards the hydrogen reaction.

Several solutions have been proposed to the problems related to the low energy density per volume for hydrogen. One alternative is to use liquids such as methanol instead of hydrogen for the anodic reaction. A reasonable rate of oxidation has been obtained with the use of methanol in PEM fuel cells. However, the lifetime of such systems is not satisfactory. This is mainly due to the cross over of methanol through the membrane. Methanol diffuses through the membrane and reacts on the cathode. CO, that poisons the catalyst, is created. To overcome this problem methanol is diluted with water. However, this reduces the energy capacity of the system.

Metal—Air Fuel Cells

An alternative approach is to use metals, as energy carriers. The energy density per unit weight and volume of metals such as Zinc (Zn), Aluminium (Al), Magnesium (Mg) or Iron (Fe) is high. For instance the theoretical energy density of Zn is 1310 Wh/kg (ΔE_{Zn-air}=1.6 V) and for Al it is as high as 8194 Wh/kg (ΔE_{Al-air}=2.75 V). In addition the use of a metal as anode material enables the fuel cell systems to be rechargeable.

An air electrode is often used as cathode in metal-air fuel cells. It is made from carbon powders with PTFE as binder forming a porous structure that allows liquid and gas transport in the same manner as for the alkaline fuel cells described above. A description of a production method for air electrodes is given in Norwegian patent application 2003 3110 belonging to the same applicant as the present invention. An alkaline solution or polymer often separates the air electrode from the metal electrode. The use of an alkaline solution gives the advantage of high kinetics for the oxygen reaction. Other solutions can be used (e.g. saltwater), however, this increases the overpotential for the oxygen reaction and thus reduces the electric efficiency of the system.

Contrary to alkaline fuel cells, in metal-air fuel cells a metal electrode is used instead of the hydrogen electrode as anode. All the energy is thus stored within the system and gas channels for hydrogen transport into the anode are not necessary. The metal electrode can be a solid plate electrode, a sintered porous electrode, a sintered mixture of the metal and oxides or an electrode of powder or pellets. The structure and design of the electrode is largely determined by the desired application. It is an advantage that the electrode is slightly porous as the metal oxides formed by metal dissolution often has a lower density than the pure metals.

Metals such as Zn, Al, Mg or Fe are good candidates due to their high energy density. If rechargeable systems are required several precautions must be taken to ensure that the dendrite growth of the metal does not short-circuit the fuel cell by connecting with the air electrode. Additives in the electrolyte can reduce the dendrite growth. In addition the metals can be alloyed to reduce dendritic growth.

One main challenge for the metal-air systems is the uncontrolled dissolution of the metal under hydrogen production. The electrolyte (often an alkaline solution) will dissolve the metals in a corrosion reaction. This reaction will proceed when the electrodes are stored at open circuit potentials and, for some metals also when the metal-air system is in use. The rate of the corrosion reaction determines the loss in electrical efficiency of the system. To reduce corrosion it has been attempted to alloy the materials (Zn, Al, Mg, Fe) with lead (Pb), mercury (Hg) or tin (Sn). These elements are known to increase the overpotential for the hydrogen reaction. An alternative approach has been to add corrosion inhibitors to the electrolyte. So far these solutions have not given satisfactory results, especially for the metals with the highest energy density (Al and Mg).

The corrosion of metals in metal—air fuel cells is considered the main cause that this type of fuel cell has not been introduced into the market. Corrosion results in a reduction of the energy capacity with time for the metals. This is due to the metal dissolution under hydrogen production.

The corrosion of the metals proceeds under hydrogen evolution according to the following equations:
M→Mⁿ⁺+ne⁻ (1)

$$n {H}_{2} O + n {e}^{-} -> n O {H}^{-} + \frac{n}{2} {H}_{2} \qquad ( 2 )$$

where n is determined by the metal (M) that is used.

This gives the following total reaction for the corrosion:

$$M + n {H}_{2} O -> {M}^{n +} + n O {H}^{-} + \frac{n}{2} {H}_{2} \qquad ( 3 )$$

As shown in Eq. 3 the amount of hydrogen evolution per metal equivalent is determined by the metal. For instance 1 mol of hydrogen is produced by the dissolution of 1 mol of Zn. With Al, on the other hand, 1.5 mol of hydrogen is produced by the dissolution of 1 mol Al.

The rate of hydrogen evolution can be found from the reversible potential for the hydrogen reaction. The reversible potential for the hydrogen reaction (Eq. 2) in an alkaline solution is −0.828 V. The open circuit potential is the potential of the metal surface when dissolution of metal is the anodic reaction and hydrogen evolution the cathodic reaction. The difference between the open circuit potential and the reversible potential for hydrogen evolution determines the cathodic reaction rate of hydrogen evolution.

If this potential difference is large (as for Al and Mg) the rate of hydrogen evolution is high and it will proceed even if the electrode is under anodic polarisation. If this potential difference is small (as for Zn) the rate of hydrogen evolution at open circuit is low and it is insignificant under anodic polarisation.

For the metal-air fuel cells this implies that with the use of metals that give a high potential difference (Al, Mg) the rate of hydrogen evolution will be high when the electrodes are stored and also significant even when the fuel cell is in use. As shown in Eq. 3 the rate of hydrogen evolution is proportional to the dissolution rate of the metal, and the dissolution rate of the metal is proportional to the loss in capacity for the metal-air fuel cell. Therefore, in order to utilise high energy density materials such as Al or Mg a solution to the problem of energy capacity loss must be found. For materials with lower hydrogen evolution rates, such as Zn and Fe, a solution is also needed if long storage times are required.

Ni/Metal Hydride Batteries

As can be seen from the descriptions above the metal-air fuel cell has close resemblance to both battery and fuel cells. The air electrode is a typical fuel cell electrode, and the metal electrode is a typical battery electrode.

Ni/Metal hydride batteries consist of a metal hydride anode and a nickel oxide cathode. The energy capacity of the system comes from hydrogen absorbed into the metal hydride alloy. This hydrogen will diffuse to the surface and react to produce electrical energy when the battery is in use. On the cathode the nickel-oxide will be reduced. An alkaline electrolyte separates the two electrodes. To obtain fast reaction rates and short diffusion paths the metal hydride electrode is made as a pressed powder tablet. A lot of work has been put into acquiring high particle to particle contact and to obtain high surface kinetics for the hydrogen reaction. Several charge recharge cycles are required to remove surface oxides on the metal hydrides and thereby activate the material. The energy capacity is limited to the amount of hydrogen inside the metal hydride. The maximum load is limited by the rate of hydrogen diffusion from the bulk to the metal hydride surface.

In the development of metal-air fuel cells the main problem has been the dissolution of the metal under hydrogen production by a corrosion reaction. This problem is especially severe with the use of metal such as Al or Mg, but also present with Zn and Fe. Especially for metal-air fuel cell applications with the use of metal powder electrodes (to reduce the voltage drop for the anodic reaction) the corrosion rate is high due to the large exposed surface area.

To solve this problem two main approaches have been used:
1. Corrosion inhibitors have been added to the electrolyte to inhibit the hydrogen reaction.
2. The metals have been alloyed with elements that increase the overpotential for the hydrogen reaction.

One attempt at improving the electrode material for fuel cells is shown in U.S. Pat. No. 5,795,669 disclosing a composite electrode material including two catalyst materials. One catalyst material is an active gas phase catalyst and the other contains an active electrochemical catalyst.

In U.S. Pat. No. 6,447,942 the use of metal storage materials for the anode in alkaline fuel cells and water electrolysis units of reversible fuel cells is shown. Such materials have high catalytic properties for the hydrogen reaction. In addition it was shown that the storage of hydrogen allows instantaneous start up of the system. The disadvantage is that conventional activation of any hydride former is accomplished by repeatedly absorbing and desorbing hydrogen under pressure. If the cells are not constructed to withstand high pressure or temperatures, this cannot be done.

In US Pat. Appl. No. 2002/0064709 a solution to the pressure problem referred to above is presented. By adding chemical hydrides (such as sodium borohydride, sodium hydride, lithium hydride etc.) in a mixture with metal hydride alloys it was proposed that hydrogen formation from the dissolution of the chemical hydrides precharges the hydrogen storage material, increases the porosity and enhances the corrosion protection of the hydrogen storage alloy. Only chemical hydrides are described in this patent as hydrogen forming materials, and the use of the chemical hydride material is limited to the above mentioned effects.

In U.S. Pat. No. 6,492,056 a composite material is made. The composite consists of hydrogen storage alloys and electrocatalytic materials. The catalytic active materials are present to increase the rate of the hydrogen reaction. In addition hydrogen storage materials are present. Hydrogen can thus be stored within the fuel cell anode or react at a high rate. This gives the advantage of instantaneous start up and the possibility to recapture energy from processes such as regenerative braking.

As can be seen from the patents above they attempt to improve the hydrogen electrode of fuel cells. Hydrogen storage materials are added to allow rapid start up of the fuel cell and chemical hydrides are added to activate the hydrogen storage materials.

In U.S. Pat. No. 6,258,482, a battery anode is made from a hydrogen storage alloy powder which includes agglomerates of hydrogen storage alloy particles joined together through a metallic layer. A metal such as Fe or Zn is suggested for the metallic layer.

In the above mentioned US patent, the objective is to enable the use of small particle sizes of hydrogen storage alloys. This will enhance the initial discharge capacity as well as increasing the charge-discharge cycle life of alkaline batteries using such hydrogen storage alloy electrodes. In order to use small metal hydride particles, the formation of oxide films must be prevented. In the US patent, it is claimed that covering the surface of the hydrogen storage alloys by a film of a metal such as Fe, Zn or others will prevent oxidation and reduce the contact resistance. The objective of the US patent is to enable the formation of a metallic surface layer on the metal hydride particles and the joining of the particles to reduce the contact resistance.

The US patent does not relate to the fact that Fe, Zn or other metals can dissolve in the alkaline environment under hydrogen production. The use of these metals as a source for hydrogen within the electrode is not the objective of the US patent.

In the present invention, the object of adding metallic particle or separate metallic layers in the electrode structure is to enable the use of high energy dense metals such as Al, Mg, Zn or Fe as a source of hydrogen for metal hydrides storage and hydrogen surface oxidation. This will utilize hydrogen formed during corrosion of the high energy dense metals and also enable hydrogen storage during charging of the battery system. In addition one embodiment of the invention is that the high energy dense metal acts as a battery anode by itself.

In the present invention corrosion is defined as the dissolution of high energy dense metals (Al, Zn, Mg or Fe) into dissolved ions or oxides. Due to the strong, alkaline electrolyte the high energy dense metals will corrode under hydrogen production. When high energy dense metals are used in battery applications (under anodic polarisation), the metals will dissolve due to the anodic potential applied. A lower rate of hydrogen production will be observed.

### SUMMARY OF THE INVENTION

In the present invention a new approach to the corrosion problem above is provided. The invention is based on the fact that only part of the energy is lost as thermal energy in the corrosion reaction and most of the energy is still present as hydrogen.

The invention also relates to a method to store and transfer this energy into electrical energy. Materials with the capacity to absorb hydrogen can be used to store hydrogen produced by corrosion, and catalytic materials for the hydrogen reaction can be used to increase the reaction rate of hydrogen oxidation. In addition to solving the corrosion problem for metal-air fuel cells the invention can also be used as the anode for metal hydride type batteries (for instance Ni-metal hydride batteries). Hydrogen storage materials are used in such batteries. A mixture of hydrogen storage materials and/or electrocatalysts and Al, Mg, Zn or Fe can replace the pure storage material as anodes for such batteries. The addition of Al, Mg, Zn or Fe will increase the lifetime and the peak power capacity of metal hydride batteries.

In this context high energy density metals are metals that react to form oxides in a reaction with oxygen (e.g. metals that corrode in the selected environments).

In the invention the objects are obtained by mixing or sintering hydrogen storage alloys and hydrogen electrocatalysts with metals such as Al, Mg, Zn and Fe. Hydrogen produced by Al, Mg, Zn and Fe then reacts on the electrocatalyst to give electrical energy. If the metal-air battery is not in use, hydrogen may be stored in the hydrogen storage material.

In a first aspect the invention provides an electrode for use in an electrochemical cell, which electrode comprises a hydrogen storage material and a high energy density metal, wherein the hydrogen storage material and the high energy density metal are disposed in the electrode in a manner such that the high energy density metal is capable of acting as a hydrogen source for the hydrogen storage material on reaction with electrolyte in the cell and/or the high energy density metal is capable of acting as anode material for the cell. In an embodiment the high energy density metal is at least one of Al, Zn, Mg and Fe, or an alloy of any of these metals. The high energy density metal may also be mixed with PTFE or graphite or both. Graphite improves the conductivity of the electrode. The hydrogen storage material may be an alloy selected from the group consisting of rare earth/misch alloys, zirkonium alloys, titanium alloys and mixtures of such alloys, and may also be mixed with PTFE and/or carbon. More specifically, the hydrogen storage material may be a metal hydride selected from a group consisting of AB₅, AB₂, AB and A₂B, where A is a Group IIb metal, transition metal, rare-earth metal, or metal of the actinide series and B is a metal of the transition series. Further, AB₅ (hexagonal or orthorhombic structure) is LaNi₅ or MmNi₅, where Mm is a combination of lanthanum and other rare-earth elements, AB₂ are ZnMn₂ with a Laves phase structure, AB is TiFe with a CsCl structure and A₂B is Ti₂Ni with a complex structure. The electrode may also comprise a hydrogen electrocatalyst, wherein the hydrogen electrocatalyst may be a noble metal (e.g. platinum (Pt) or palladium (Pd)), or Nickel (Ni), iron (Fe) or chromium (Cr) or an alloy comprising at least one of the metals platinum (Pt), palladium (Pd), Nickel (Ni), iron (Fe) or chromium (Cr). In an even further embodiment the hydrogen electrocatalyst is a pure powder deposited onto a support material with high surface area e.g. activated carbon or graphite.

In an even further embodiment of the invention the high energy density metal and the hydrogen storage alloy forms one sheet. In another embodiment the high energy density metal, the hydrogen storage alloy and the electrocatalyst forms one sheet. It is also possible that the electrode is made of two sheets, wherein the high energy density metal forms a first sheet and the hydrogen storage alloy forms a second sheet or where the high energy density metal and the electrocatalyst form a first sheet and the hydrogen storage alloy forms a second sheet. A three layer electrode is accomplished when the high energy density metal forms a first sheet, the hydrogen storage alloy forms a second sheet and the electrocatalyst forms a third sheet.

A mesh current collector may be pressed or calendered into one of the sheets. The high energy density metal may be made from a solid plate, pellets or powder. Further the high energy density metal may be mixed with PTFE (Teflon) and/or graphite. Also the hydrogen storage material may be made from a solid plate, pellets or powder mixed with PTFE (Teflon) or graphite. The electrode layers may be made as an energy carrier layer, a catalyst layer, an absorption layer and a mesh current collector or mechanical support.

In a second aspect the invention provides a method for the production of an electrode for use in an electrochemical cell, which electrode comprises a hydrogen storage alloy and a high energy density metal, the method comprising sintering or forming with a binder a high energy density metal powder and/or hydrogen storage alloy into at least one thin sheet and calendaring or pressing the sheet to form the electrode. The porosity may be controlled by using PTFE as the binder. Particle to particle contact may be increased by adding carbon. In a further embodiment a current collector is pressed or calendared into the sheet.

In a third aspect the invention provides a metal-air fuel cell comprising an anode electrode according to the above. In a fourth aspect the invention provides a metal hydride cell comprising an anode electrode as stated above.

In a fifth aspect the invention provides use of a high energy density metal in combination with a hydrogen storage material for corrosion prevention in metal-air fuel cells, and in a sixth aspect the invention provides use of a high energy density metal in combination with a hydrogen storage material providing self-charging in Ni-Metal hydride batteries. In a seventh aspect use of a high energy density metal in combination with a hydrogen storage material in an electrode in Ni-Metal hydride batteries is provided for increased energy capacity. In an even further aspect use of a high energy density metal for increased peak power in Ni-Metal hydride batteries is provided. Further, in a ninth aspect use of high energy density metals such as Al, Zn, Mg or Fe to prevent corrosion of the metal hydride in Ni-Metal hydride batteries is provided. Further, in a tenth aspect there is provided use of a hydrogen storage material in an electrode of an electrochemical cell, which electrode also contains a high energy density material, for absorbing hydrogen produced by reaction of the high energy density metal with electrolyte, in the cell. Further, in an eleventh aspect of the invention there is provided use of a high energy density metal in an electrode of an electrochemical cell, which electrode also contains a hydrogen storage material, as a hydrogen source for the hydrogen storage material on reaction of the high energy density metal with electrolyte in the cell.

According to the knowledge of the inventor only a few patents have been reported combining materials to utilise several properties for fuel cell electrodes. These have been referenced above. So far the use of hydrogen storage materials and electrocatalysts in the metal electrode for metal-air fuel cells have not been reported. The use of hydrogen storage materials in the hydrogen electrode for alkaline fuel cells (AFC) and also the use of chemical hydrides that react to form hydrogen are known. However, these electrodes deviate from the metal electrodes described herein in a number of ways. The prior art electrodes are made to give the alkaline fuel cell rapid start up. It has also been proposed that with these additives (metal hydride) it is possible to reverse the fuel cell and use it for water electrolysis. The AFC anodes are constructed with the use of porous electrode production methods to assure sufficient gas transport from the environment. This deviates from the present invention as the metal electrode in metal-air fuel cells has no interaction with the environment. The hydrogen storage materials in the earlier mentioned patents are tailor made for rapid absorption and desorption of hydrogen to increase the dynamic behaviour of alkaline fuel cells.

All of the earlier mentioned patents are limited by the need for a supply of hydrogen from the environment in order to function. None of the patents deal with the aspect of using a high energy density metal such as Al, Zn, Mg or Fe to store energy within the system, and the release of this energy by the corrosion of such metals.

In the present invention hydrogen storage materials and/or electrocatalysts are used in combination with a metal such as Al, Zn, Mg or Fe. This is done to increase the electrical energy efficiency of the metals. Such metals can also in combination with hydrogen storage materials be used as the anode for Ni/Metal hydride batteries. This will give increased energy capacity of the systems and increase the peak load for such batteries.

The invention is defined in the appended claims.

### BRIEF DESCRIPTION OF DRAWINGS

Embodiments of the invention will be described in the following, where

FIG. 1 illustrates a possible assembly method for an electrode according to an embodiment of the invention, by the use of several sheets with different properties;

FIG. 2 shows a two layer electrode according to an embodiment of the invention including a hydrogen absorber (metal hydride) and an electrocatalyst in one layer and an energy carrier (high energy density metal) in a separate layer;

FIG. 3 shows a one layer electrode including an energy carrier (high energy density metals), a hydrogen absorber (metal hydrides) and an electrocatalyst according to an embodiment of the invention;

FIG. 4 illustrates an electrode according to an embodiment of the invention used in a nickel-metal hydride battery;

FIG. 5 illustrates an electrode according to an embodiment of the invention used in a metal-air fuel cell;

FIG. 6 shows a resistor connected in the galvanic coupling between a metal hydride and high energy density metals in an electrode according to an embodiment of the invention;

FIG. 7 shows current density for anodic polarisation of (+100 mV) of electrodes according to an embodiment of the invention prepared from 20 wt % Mg mixed with 65 wt % carbon with and without 1 wt % Pt catalyst and 15 wt % PTFE, and with an electrolyte of 6.6 M KOH at 20° C.;

FIG. 8 shows polarisation sweeps of electrodes according to an embodiment of the invention prepared from 20 wt % Zn, 65 wt % carbon support with or without 1 wt % Pt catalyst and 15 wt % PTFE;

FIG. 9 shows the rate of hydrogen oxidation in 6.6 M KOH at 20° C. on a PTFE bounded carbon electrode with 1 wt % Pt catalyst on the carbon support; and

FIG. 10 shows hydrogen oxidation at an overpotential of +100 mV in 6.6 M KOH on a electrode according to an embodiment of the invention containing a Ni-P alloy that was deposited on Al and a carbon pore former.

### DETAILED DESCRIPTION

In an embodiment of the present invention energy dense metals are combined with hydrogen storage materials (as used in Ni/Metal hydride batteries) and electrocatalytic materials. This enables hydrogen from the corrosion of the energy dense metals to be stored within the metal hydride material or to react in an electrochemical reaction on the electrocatalyst. In this way the energy loss by corrosion of the energy carrier (Al, Mg, Zn or Fe) is minimised, and the energy density of metal hydride batteries can be increased.

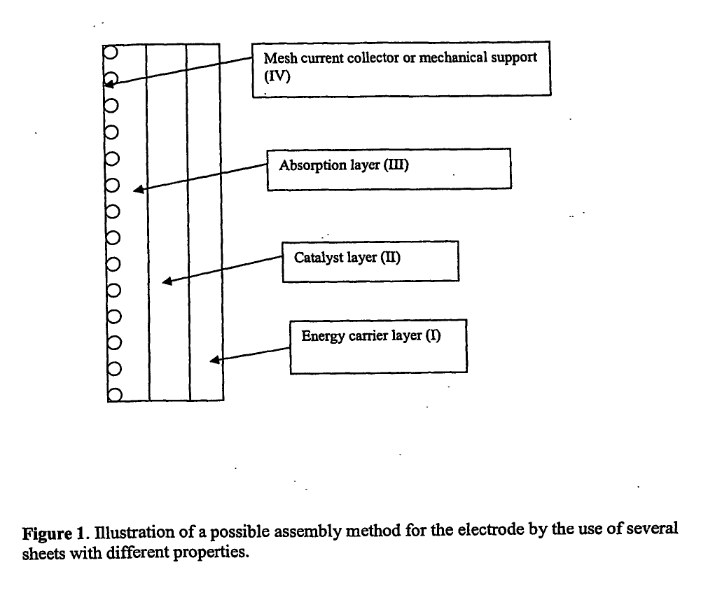

An embodiment of the electrode according to the invention is shown in FIG. 1. The electrode consist of four layers; an energy carrier layer (I), (Zn, Al, Mg or Fe), a catalyst layer (II) (porous electrocatalyst with or without a support material), and an absorption layer (III) (hydrogen storage materials). These layers are prepared in thin sheets and pressed together. A mesh current collector (VI) can be pressed or calendared into one or all of the sheets. However, other embodiments with fewer layers are also possible, which will be explained later.

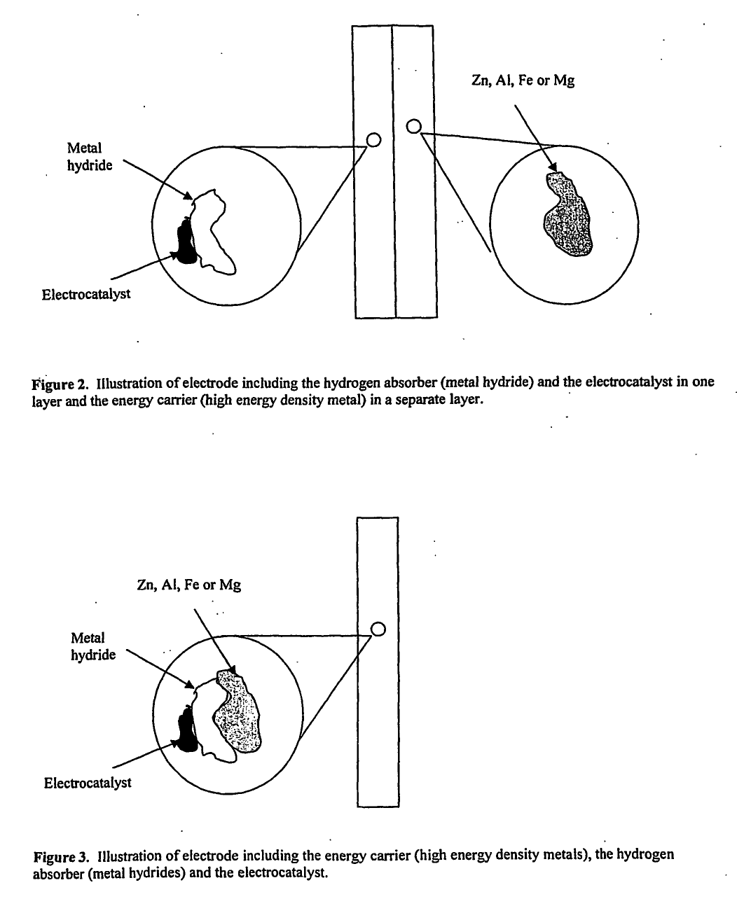

The electrodes can be produced by several methods. The best method is based on the use of metal powders that are sintered or formed with a binder into thin sheets with a controlled porosity by using PTFE as the binder. To increase the particle to particle contact carbon can be added. The electrodes can be produced by calendaring or pressing. FIG. 1 shows a method of assembly of an electrode according to an embodiment of the invention. In FIG. 1 the energy carrier layer (I), (Zn, Al, Mg or Fe), the catalyst layer (II) (porous electrocatalyst with or without a support material) and the absorption layer (III) (hydrogen storage materials) are prepared in thin sheets that are pressed together. A mesh current collector (VI) can be pressed or calendared into one or all of the sheets. Hydrogen (formed by corrosion of the energy carrier) will diffuse into the hydrogen storage layer or react on the electrocatalyst layer. It is also possible to use only one or two sheets. This is done by mixing the energy carrier with the hydrogen storage material into one sheet or by mixing the hydrogen storage material with the electrocatalyst into one sheet or mixing the electrocatalyst and the energy carrier into one sheet or by mixing all the components into only one sheet (Illustrated in FIG. 2 and FIG. 3). Some of these possibilities will be illustrated further by examples given below.

FIGS. 2 and 3 show 2 alternative embodiments of the invention. In FIG. 2 the electrode is made from two layers, and in FIG. 3 the electrode is made by one layer. In FIG. 2 the hydrogen absorber (metal hydride) and the electrocatalyst are prepared in one layer and the energy carrier (high energy density metal, e.g. Zn, Al, Fe or Mg) is prepared in a separate layer. In FIG. 3 the energy carrier (high energy density metals, e.g. Zn, Al, Fe or Mg) together with the hydrogen absorber (metal hydrides) and the electrocatalyst are prepared in one layer.

The advantage of using three separate layers is that a better control of the reactions on the individual sheets can be obtained. On the other hand, by mixing more than one of the materials into the same sheet the diffusion paths becomes shorter and the interaction between the individual powders are increased. Another benefit is that this may result in simpler production methods by having fewer mixing and calendaring steps.

As mentioned previously the energy carrier for a metal-air fuel cell is a metal such as Zn, Al, Mg or Fe. A large number of hydrogen storage materials exist that can be used. The major classes of intermetallic alloys that form metal hydrides are AB₅ AB₂ AB and A₂B where A is a Group IIb metal, transition metal, rare-earth metal, or metal of the actinide series; B is a metal of the transition series. Examples of AB₅ (hexagonal or orthorhombic structure) are LaNi₅ or MmNi₅ where Mm, or misch metal, is a combination of lanthanum and other rare-earth elements. An example of AB₂ is ZnMn₂ with a Laves phase structure. An example of AB is TiFe with a CsCl structure. An example of A₂B is Ti₂Ni with a complex structure.

To catalyze the oxidation of hydrogen, noble metals such as platinum (Pt) or palladium (Pd) can be used. They can be present in the form of pure powders or deposited onto a support material with high surface area such as activated carbon or graphite. Nickel (Ni), iron (Fe) and chromium (Cr) are less expensive materials that can be used to catalyze hydrogen oxidation. To increase the catalytic activity they can be in the form of powders with high surface area. An alternative is that they are deposited onto a support material. To further increase the catalytic activity amorphous alloys of Ni, Cr and Fe can be used. To form such alloys electrochemical or chemical deposition of Ni, Cr or Fe with co-deposition of sulphur (S), boron (B) or phosphorus (P) is performed. Such alloys also absorb hydrogen and may act as hydrogen storage materials. The metal hydride materials described above have shown high catalytic activity for the hydrogen reaction and may be used as combined storage materials and electrocatalysts.

Another possibility is that the electrocatalysts are deposited onto the hydride storage alloys or that the electrocatalysts are deposited onto the energy carriers (Zn, Al, Mg, or Fe). The last possibility is that the storage alloys with or without electrocatalysts are deposited onto the energy carriers.

A solid plate or pellets made from the high energy density metals can be made in a separate sheet. This sheet can be combined with a metal hydride sheet or an electrocatalyst sheet or a sheet with a combination of metal hydride and electrocatalyst. In FIG. 2 this configuration is shown with the use of powders as energy carrying materials. In this configuration the powders can be replaced by a solid plate or pellets.

FIG. 5 shows an electrode according to the invention used in a metal-air fuel cell. The electrode according to the invention is used as the anode, and an air electrode reducing oxygen from air is used as the cathode. An alkaline electrolyte separates the two electrodes. On the cathode, oxygen from air diffuses into the porous electrode. From the opposite side the electrolyte partially floods the structure. A three phase boundary is obtained within the cathode. The high surface area enables high reaction rates of oxygen. On the anode, metal and/or hydrogen oxidation occurs. When the anode and the cathode are connected a current will flow through the system.

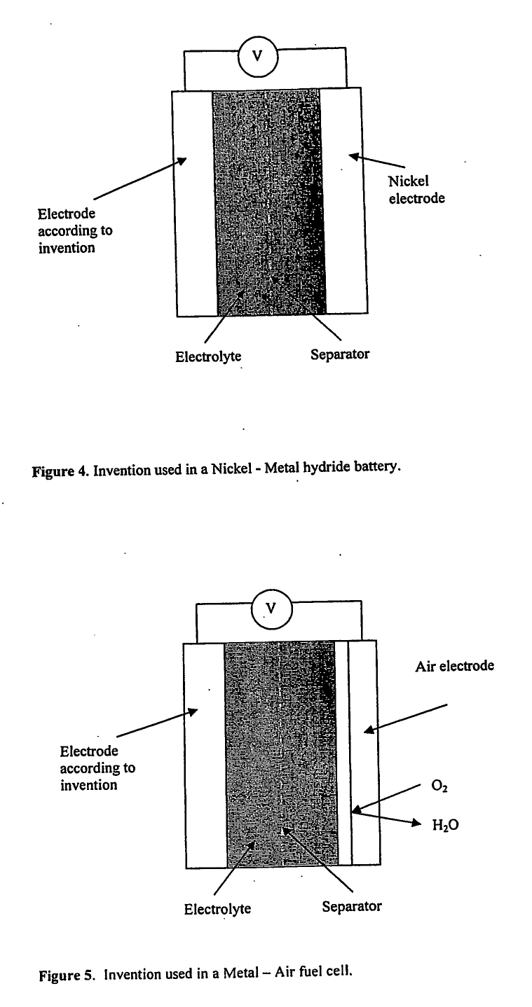

Another application for the electrode according to the invention is to use it in metal hydride batteries (such as Ni-metal hydride batteries) e.g. as shown in FIG. 4. In FIG. 4 the electrode according to the invention is used as the anode, while the nickel electrode is used as the cathode. An alkaline electrolyte separates the two electrodes. To prevent short circuiting of the cell a separator is introduced between the electrodes.

As are shown in the examples below, it is possible to mix metals (Zn, Al, Mg or Fe) with hydrogen storage materials. By applying a mixture of storage materials and energy carrying materials (Al, Mg, Fe, Zn) instead of a pure hydrogen storage material, the battery becomes self-charged. Hydrogen is slowly produced from the dissolution of the energy carrying metals (Zn, Al, Mg or Fe). The hydrogen that is formed by corrosion of Zn, Al, Mg or Fe then diffuses into the metal hydride storage material and charges the system. This will increase the lifetime of the battery significantly.

The dissolution of the energy carriers and the hydrogen absorption-desorption reactions are reversible and thus such a battery can be recharged. In addition the effect of energy carrier metals in Ni/Metal hydride batteries will increase the peak power as dissolution of the energy carrier has low polarisation losses and no diffusion limitation.

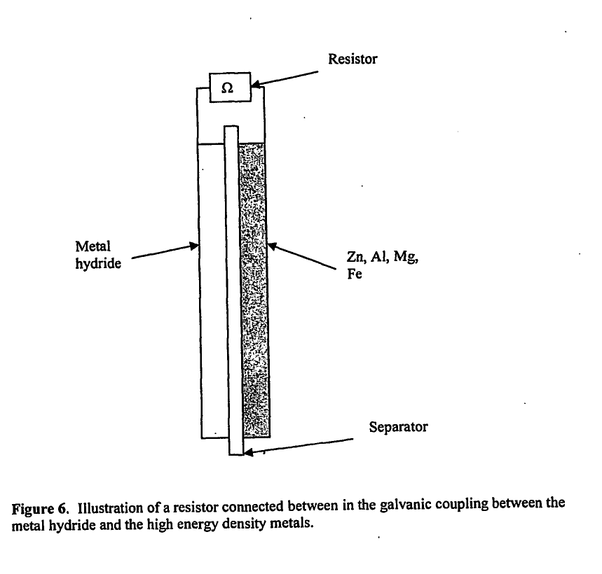

Additional benefits are that a galvanic coupling between metals such as Zn, Al, Mg and Fe and more noble metals such as Ni based storage alloys, can be formed. This will result in cathodic polarisation of the more noble metal and ease the adsorption and absorption of hydrogen. Additional benefits from a galvanic coupling are that it may reduce the corrosion rate of the storage alloys and thus increase the lifetime of Ni/Metal hydride batteries. If the energy carrier material (Al, Zn, Mg or Fe) and the storage alloy are separated in two sheets, a resistor may be introduced between the galvanic coupling of the materials. This may be beneficial to reduce the cathodic overpotential for the storage alloy and thereby reduce hydrogen evolution on this alloy. This is shown in FIG. 6.

### EXAMPLES

### Example 1

In the following example the effect of adding an electrocatalyst to the metal electrode is illustrated. It is shown that the electrocatalyst will increase the total current density by oxidation of the hydrogen that is produced by the corrosion reaction on the metals.

A powder electrode was prepared by the use of metal powders, such as Zn, Al, Mg or Fe, a carbon powder with and without catalyst support and PTFE. The electrode was prepared by mixing the powders in a high speed mill at 20 000 rpm. This produced an agglomerate. The agglomerate was made into a clay by the use of a hydrocarbon solvent. The clay was calendared into an electrode. A Ni mesh was calendared into the electrode as a current collector. The amount of metal (Zn, Mg, Al, Fe) was varied from 5 to 95 wt %. At least 5 wt % PTFE was added to bind the electrode together.

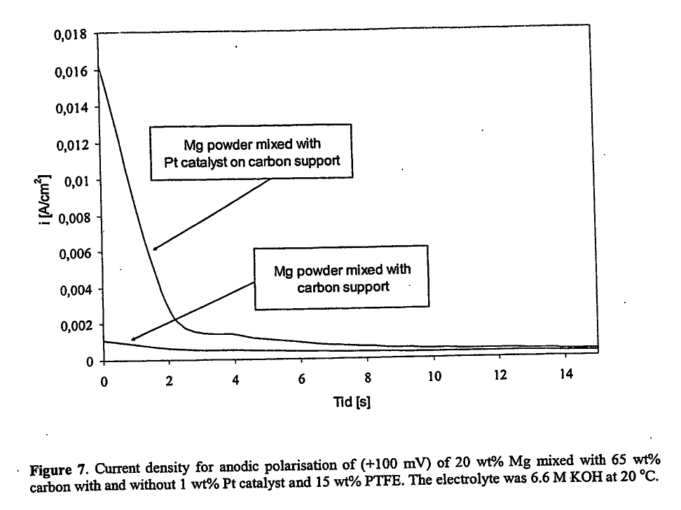

FIG. 7 shows the rate of hydrogen oxidation on a Pt catalyst and the dissolution current for Mg dissolution. The figure shows the current density i [A/cm²] as a function for time T[s] for anodic polarisation (+100 mV) of electrodes prepared from 20 wt % Mg mixed with 65 wt % carbon and 15 wt % PTFE with an electrolyte of 6.6 M KOH at 20° C. Two electrodes were prepared, one with a platinum (Pt) catalyst on a support carbon, the other with a support carbon without Pt catalyst. For the sample with Pt on the carbon support the amount of Pt deposited on the carbon was 1 wt %.

In this example the high energy density metal (Mg) and the catalyst (Pt on carbon support) was prepared in one layer. The objective was to determine the effect of the catalyst on the hydrogen produced by Mg dissolution. This is obtained by comparing the electrode containing Pt catalyst with an electrode without Pt on the carbon support.

For the sample without catalyst the current is due only to dissolution of Mg. For the sample with added Pt-catalyst an additional contribution to the current is observed. This current is due to hydrogen oxidation on the catalyst.

A drop in the current density with time is observed for hydrogen oxidation. This is due to the applied anodic potential. Anodic polarisation reduces the rate of hydrogen production from Mg and, therefore, also the amount of hydrogen available for oxidation.

The experiment clearly illustrated the benefit of adding electrocatalysts to the metal electrodes in metal-air fuel cells as this will increase the current by the oxidation of hydrogen formed from corrosion or anodic dissolution of metals.

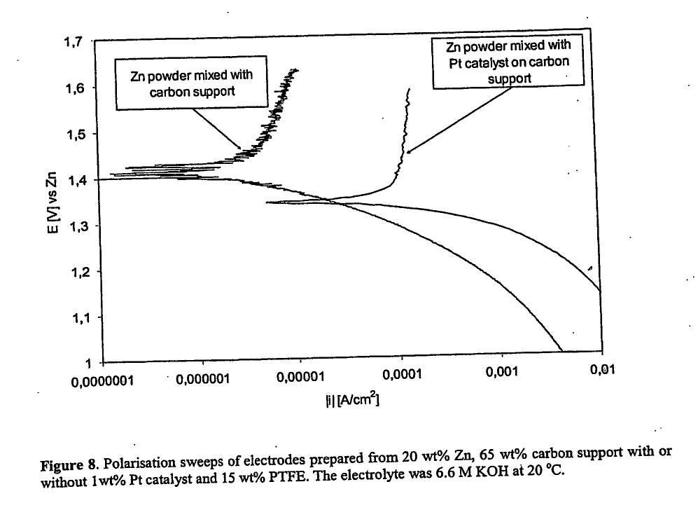

FIG. 8 shows polarisation sweeps, where the current density I [A/cm²] is shown as a function of time T [s], for two Zn electrodes prepared in the same manner as described above for the Mg electrodes. Again one electrode is prepared with Pt-catalyst and the other without. From the anodic polarisation sweeps it can clearly be seen that the rate of oxidation is enhanced greatly by the addition of Pt-catalyst also for metals with a lower hydrogen production rate. The electrodes in FIG. 8 were prepared from 20 wt % Zn, 65 wt % carbon support and 15 wt % PTFE. The electrolyte was 6.6 M KOH at 20° C. Also for these electrodes one electrode was made with 1 wt % Pt deposited onto the carbon support and one with a pure carbon support.

### Example 2

As shown in FIG. 1 and FIG. 2 electrodes can be prepared by connecting several layers with different composition. In the following example it is shown that hydrogen formed in a pure energy carrier metal layer will diffuse into a pure catalyst layer and there be oxidised to give an additional contribution to the current.

Two separate layers were prepared and then combined by calendaring them together. One layer was prepared with a high energy density metal the other was a carbon layer. Both layers were made from powders by agglomerating and calendaring as described above. No catalyst or carbon was present in the metal electrode, only PTFE and metals such as Al, Zn, Mg, Fe or combinations of these metals. Carbon electrodes were prepared by the use of 15 wt % PTFE and 85 wt % carbon.1 wt % Pt was deposited onto the carbon support.

When carbon is used in a layer a porous structure is obtained. This allows rapid diffusion of hydrogen into the layer. The catalyst (Pt) on the carbon support enables hydrogen oxidation.

The two layers were assembled and pressed together. To prevent electrical contact between the layers a porous polypropylene sheet was placed between the two layers. The perforated polypropylene sheet did not prevent gas diffusion. In this way the current-potential relationship for the two layers could be measured individually.

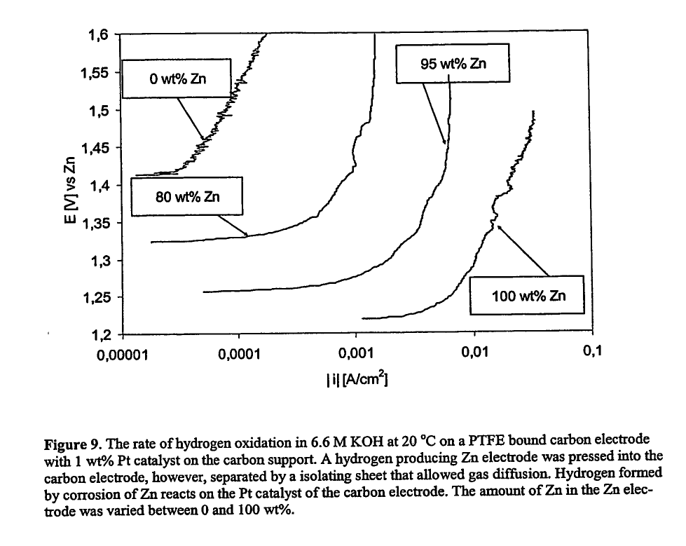

FIG. 9 shows the anodic current i [A/cm²] on the carbon layer with Pt-catalyst as a function of applied potential E for different amounts of Zn in the metal electrode. FIG. 9 shows the rate of hydrogen oxidation for this layer in 6.6 M KOH at 20° C. Hydrogen formed by corrosion of Zn, diffuses into the carbon layer and reacts on the Pt catalyst. The amount of Zn in the Zn layer was varied from 0 to 100 wt %; and FIG. 9 shows graphs for 0%, 80%, 95% and 100% Zn. For the 100% Zn sample a pure Zn plate was used.

As can be seen a diffusion limited anodic reaction occurs for the carbon electrode. This is due to the fact that hydrogen produced at the Zn-electrode diffuses into the carbon electrode and reacts on the catalyst. By reducing the amount of PTFE in the Zn-electrode, hydrogen production from the Zn-electrode is increased. As shown in FIG. 9 the diffusion limited hydrogen oxidation reaction is increased on so the carbon electrode with increased hydrogen production.

The example clearly shows that hydrogen produced by unwanted corrosion of metals such as Al, Mg, Zn and Fe can be utilised in a separated carbon layer with electrocatalyst. The use of a catalyst layer gives the advantage that the electrical energy efficiency of the high energy density metal is increased. In this way the energy loss due to the metal dissolution is minimised.

### Example 3

In the following example it is shown that hydrogen production by corrosion of metals can be stored in hydrogen storage metals and react on the surface of the storage metals.

Electrodes were prepared with metals powders of Al, Fe, Zn or Mg, carbon with or without catalyst and PTFE. A Ni alloy with storage capacity of hydrogen was deposited onto the metal powders. This was done either by electrochemical or electroless deposition of Ni-P. The powders were agglomerated and calendared as described above.

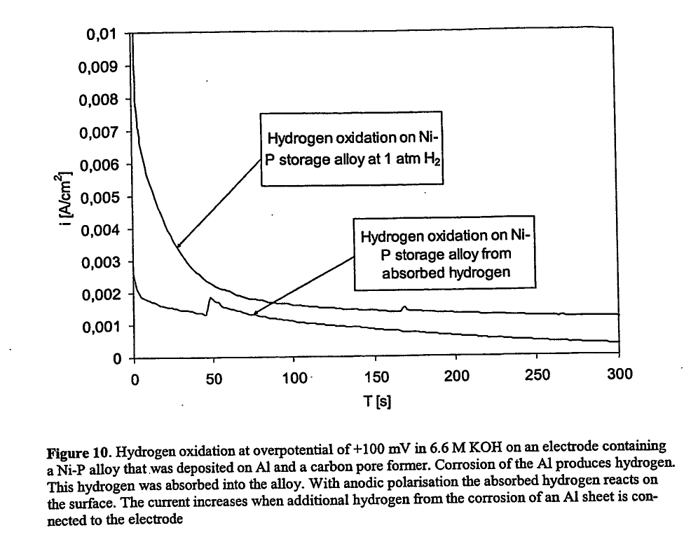

FIG. 10 shows hydrogen oxidation at an overpotential of +100 mV in 6.6 M KOH on an electrode according to an embodiment of the invention containing a Ni—P alloy that was deposited on Al and a carbon pore former. Corrosion of the Al produces hydrogen. This hydrogen was absorbed into the alloy. With anodic polarisation the absorbed hydrogen reacts on the surface. The current increases when additional hydrogen from the corrosion of an Al sheet is connected to the electrode,

In FIG. 10 the current density i [A/cm²] at an anodic overpotential of 100 mV is shown as a function of time T[s]. The current measurements have been taken after corrosion has dissolved the entire Al. The lowest current density curve shows oxidation of hydrogen that has been stored in the Ni—P alloy during dissolution of the Al. The highest current density curve shows hydrogen oxidation when an additional layer of Al is dissolved and hydrogen diffuses into the electrode and reacts with the catalytic surface of the Ni—P alloy.

The example illustrates that hydrogen from the corrosion of metals can be stored in a hydrogen storage alloy during dissolution of the metal and that at anodic over-potentials this hydrogen will react on the surface of the storage alloy. In this way the loss in electrical energy capacity by the dissolution of the high energy density metal can be minimised by storing energy as hydrogen in metal hydrides. This hydrogen can be efficiently converted to electrical energy by the use of catalysts for the hydrogen reaction.

Having described specific embodiments of the invention it will be apparent to those skilled in the art that other embodiments incorporating the concepts may be used. These and other examples of the invention illustrated above are intended by way of example only and the actual scope of the invention is to be determined from the following claims.

1. An electrode for use in an electrochemical cell, said electrode comprising a hydrogen storage material and a high energy density metal, wherein the hydrogen storage material and the high energy density metal are disposed in the electrode in a manner such that the high energy density metal is capable of acting as a hydrogen source for the hydrogen storage material on reaction with electrolyte in the cell and/or the high energy density metal is capable of acting as anode material for the cell.

2. An electrode according to claim 1, wherein the high energy density metal is at least one of Al, Zn, Mg and Fe, or an alloy of any thereof.

3. An electrode according to claim 1 or 2, wherein the high energy density metal is mixed with polytetrafluoroethylene.

4. An electrode according to any of claims 1 to 3, wherein the high energy density metal is mixed with graphite, said graphite increasing electrode conductivity.

5. An electrode according to any of claims 1 to 4, wherein the hydrogen storage material is an alloy selected from the group consisting of rare earth/misch alloys, zirkonium alloys, titanium alloys and mixtures of such alloys.

6. An electrode according to claim 1 or 5, wherein the hydrogen storage material is mixed with polytetrafluoroethylene.

7. An electrode according to any of claims 1 to 6, wherein the hydrogen storage material is mixed with carbon.

8. An electrode according to any of claims 1 to 7, wherein the hydrogen storage material is a metal hydride selected from the group consisting of AB₅, AB₂, AB and A₂B, where A is a Group lib metal, transition metal, rare-earth metal or metal of the actinide series and B is a metal of the transition series.

9. An electrode according to claim 8, wherein:
AB₅ has hexagonal or orthorhombic structure and is LaNi₅ or NmNi₅, where Nm is a combination of La and other rare-earth elements;
AB₂ is ZnMn₂ with a Laves phase structure;
AB is TiFe with a CsCI structure; and
A₂B is Ti₂Ni with a complex structure.

10. An electrode according to any of claims 1 to 9, which further comprises a hydrogen electrocatalyst.

11. An electrode according to claim 10, wherein the hydrogen electrocatalyst is a noble metal, Ni, Fe, Cr or an alloy comprising at least one of these metals.

12. An electrode according to claim 10 or 11, wherein the hydrogen electrocatalyst is in the form of a pure powder deposited on a high surface area support material.

13. An electrode according to claim 12, wherein the high surface area support material is activated carbon or graphite.

14. An electrode according to any of claims 1 to 13, wherein the high energy density metal and the hydrogen storage material are in the form of a single sheet.

15. An electrode according to any of claims 10 to 13, wherein the high energy density metal, the hydrogen storage material and the hydrogen electrocatalyst are in the form of a single sheet.

16. An electrode according to any of claims 1 to 13, wherein the high energy density metal is in the form of a first sheet and the hydrogen storage material is in the form of a second sheet.

17. An electrode according to any of claims 10 to 13, wherein the high energy density metal and the hydrogen electrocatalyst are in the form of a first sheet and the hydrogen storage material is in the form of a second sheet.

18. An electrode according to any of claims 10 to 13, wherein the high energy density metal is in the form of a first sheet, the hydrogen storage material is in the form of a second sheet and the hydrogen electrocatalyst is in the form of a third sheet.

19. An electrode according to any of claims 14-18, wherein a mesh current collector is pressed or calendered into one of the sheets.

20. An electrode according to any of claims 1 to 19, wherein the high energy density metal is in the form of a solid plate, pellets or powder.

21. An electrode according to any of claims 1 to 20, which comprises: an energy carrier layer; a catalyst layer; a hydrogen absorption layer; and one or both of a mesh current collector and a mechanical support.

22. Use of a hydrogen storage material in an electrode of an electrochemical cell, said electrode also containing a high energy density metal, for absorbing hydrogen produced by reaction of said high energy density metal with electrolyte in said cell.

23. Use of a high energy density metal in an electrode of an electrochemical cell, said electrode also containing a hydrogen storage material, as a hydrogen source for said hydrogen storage material on reaction of said high energy density metal with electrolyte in said cell.

24. A method for the production of an electrode for use in an electrochemical cell, said electrode comprising a hydrogen storage alloy and a high energy density metal, the method comprising: sintering or forming with a binder at least one of a high energy density metal and a hydrogen storage alloy into at least one thin sheet; and calendaring or pressing said at least one sheet to form the electrode.

25. A method according to claim 24, wherein porosity is controlled by using polytetrafluoroethylene as a binder.

26. A method according to claim 24 or 25, wherein particle to particle contact is increased by adding carbon.

27. A method according to any of claims 24 to 26, wherein a current collector is pressed or calendared into said at least one sheet.

28. A metal-air fuel cell or metal hydride battery cell comprising as anode an electrode according to any of claims 1 to 21.

29. A metal-air fuel cell wherein the negative electrode comprises a high energy density metal and a hydrogen storage material, said hydrogen storage material being disposed within the electrode such that it is adapted to absorb hydrogen produced by reaction of high energy density metal and electrolyte in said cell.

30. A metal hydride cell wherein the negative electrode comprises a high energy density metal and a hydrogen storage material, said high energy density metal being disposed within the electrode such that it is adapted to provide a hydrogen source for the hydrogen storage material on reaction with the electrolyte in said cell.

31. A cell according to claim 30 which is a nickel-metal hydride cell.

32. Use of a hydrogen storage material in combination with a high energy density metal in an electrode in a metal-air fuel call for prevention of corrosion of the electrode.

33. Use of a high energy density metal in combination with a hydrogen storage material in an electrode in a nickel-metal hydride battery to provide self-charging in the battery.

34. Use of a high energy density metal in combination with a hydrogen storage material in an electrode in a nickel-metal hydride battery to provide increased energy capacity in the battery.

35. Use of a high energy density metal in combination with a hydrogen storage material in an electrode in a nickel-metal hydride battery to provide increased peak power in the battery.

36. Use of a high energy density metal in an electrode in a nickel-metal hydride battery to prevent corrosion of the metal hydride by arranging galvanic coupling between separated layers containing high energy density metal and metal hydride respectively.

37. Use according to any of claims 22, 23 or 32 to 36, wherein the high energy density metal is Al, Zn, Mg or Fe.
